(19) United States
(12) Patent Application Publication
(10) Pub. No.: US 2006/0208086 A1
(43) Pub. Date: Sep. 21, 2006

(54) Multifunction trigger for RFID and optical readers

(75) Inventors: Robert W. Rudeen, Eugene, OR (US); Craig H. Bontly, Eugene, OR (US); Michael P. Svetal, Eugene, OR (US)

Correspondence Address: PSC SCANNING, INC. - STOEL RIVES LLP;C/O STOEL RIVES LLP, 900 SW 5TH AVENUE, SUITE 2600, PORTLAND, OR, 97204, US

(73) Assignee: PSC Scanning, Inc., Eugene, OR (US)

(21) Appl. No.: 11/377,918

(22) Filed: Mar. 15, 2006

Related U.S. Application Data
(60) Provisional application No. 60/714,552, filed on Mar. 15, 2005.

(51) Int. Cl. G06K 7/10

(52) U.S. Cl. 235/472.01; 235/462.48

(57) ABSTRACT

Methods and apparatuses for operating a handheld data reader are disclosed, including a trigger mechanism in communication with a control unit of the data reader for activating different functions of the data reader in response to the application of different manual manipulation inputs to the trigger. In response to a first triggering manipulation, the trigger mechanism preferably generates a first signal; and in response to a second triggering manipulation, the trigger mechanism preferably generates a second signal distinguishable from the first signal by the control unit. The control unit may be responsive to receipt of the first signal to activate a first function of the data reader and responsive to receipt of the second signal to activate a second function of the data reader. Exemplary first and second trigger manipulations include push/pull, single-click/double-click, and high force/low force, among others.

### RELATED APPLICATION

This application claims the benefit of priority under 35 U.S.C. § 119(e) of U.S. Patent Application No. 60/714,552, filed Mar. 15, 2005, which is incorporated herein by reference.

### BACKGROUND

The field of the disclosure relates to data readers, such as RFID interrogators and optical code readers, for example; and, more particularly, to triggering apparatuses and methods for activating multiple functions of a data reader.

Optical data readers include devices for sensing illumination and typically illumination that is reflected by a surface being read. One type of data reader is an optical scanner or laser scanner for reading optical codes comprised of dark elements separated by white or light-colored spaces. A 1-D bar code (such as a UPC or EAN/JAN bar code) is an example of an optical code readable by such an optical scanner, although 2-D codes, such as PDF-417 and Maxicode, are also readable using similar methods and equipment. Other types of optical data readers are useful for reading other image data and other kinds of symbols.

Imaging devices such as charge-coupled devices (CCDs) and complementary metal oxide semiconductor imagers (CMOS imagers) can be used to capture image data for use in data reading applications. In such devices, an image of the optical code or other scene is focused onto a detector array. The image data produced by the imager may be captured by the imager and processed in a computer processor utilizing reader algorithms to read the optical code. The image data may also be manipulated in other ways or stored for later use or display.

The use of Radio Frequency Identification (RFID) transponders or tags to identify an object or objects is well known in the art of RFID systems. Typically, when RFID tags are excited they produce or reflect a magnetic or electric field at some frequency, which is modulated with an identifying code or other useful information. The tag may either be active or passive. Active tags have a self-contained power supply. Passive tags require external excitation when they are to be read. In passive tag systems, an interrogator or reader contains a transmitting antenna for sending an exciting frequency signal to a passive tag located within the detection volume of the reader. A receiving antenna of the reader receives a modulated signal (magnetic or electromagnetic) produced by the excited tag. This modulated signal identifies the tag and consequently, the object attached thereto. Some interrogators have a trigger or switch that allows the user to manually activate the interrogator when desired. For example, a user may switch on an RFID reader that powers an interrogator to send a downlink electromagnetic signal to a tag to detect and identify it.

Some retail environments include items carrying an RFID tag and other items carrying an optical code, such as a bar code or other optical symbol; and some items in a retail environment may carry both an RFID tag and an optical code. With these retail items, an optical reader such as a laser scanner or imaging reader is needed to read optical code labels and a separate RFID reader is needed to detect and identify RFID tags.

Dual-technology devices embodying both optical bar code reading and RFID reading functionality have been developed to read both bar codes and RFID tags. Examples of such dual-technology devices are described in U.S. Pat. No. 5,382,784 of Eberhardt; U.S. Pat. No. 5,801,371 of Kahn et al.; U.S. Pat. No. 6,415,982 of Bridgelall et al.; and U.S. Pat. No. 6,234,394 of Kahn et al.

In each of these existing systems, a manual trigger for activating an optical reader or RFID reader has limitations or disadvantages. For example, one embodiment of a handheld reader described in U.S. Pat. No. 5,801,371 of Kahn et al. includes two manually actuated trigger switches spaced apart along a grip of the reader, as well as a thumb-actuated trackball or joystick located along a top portion of the reader housing. The use of numerous manual controls and switches increases the cost and complexity of the reader and may make it more susceptible to failure. The present inventors have also recognized that it is easier to design a reader housing with a waterproof seal when fewer switches are used.

The present inventors have recognized a need for an improved method of triggering a data reader that enables a user to conveniently select from and operate multiple functions of the data reader, or to change an operating mode of the data reader, with a simple trigger design.

### SUMMARY

According to embodiments described herein, a method of operating a handheld data reader including a manual trigger in communication with a control unit may comprise activating different functions of the data reader by applying different manual manipulation input to the trigger. For example, a trigger may include a single-throw switch, a rocker switch, or any other simple switch or mechanism that, when pressed in accordance with a first triggering manipulation, generates a first signal; and that, when pressed in accordance with a second triggering manipulation, generates a second signal distinguishable from the first signal by the control unit. The control unit is preferably responsive to receipt of the first signal to activate a first function of the data reader, and responsive to receipt of the second signal to activate a second function of the data reader.

In one embodiment, the first triggering manipulation includes pulling the trigger in a first direction and the second triggering manipulation includes pushing the trigger in a second direction opposite the first direction.

In another embodiment, the trigger includes a rocker switch having a control arm that is rocked in a first direction to produce the first signal and in a second direction opposite the first rotational direction to produce the second signal.

In still another embodiment, the first triggering manipulation is a single click and the second triggering manipulation is a series of two clicks close in time (i.e., a “double click” similar to the double click action of a computer mouse).

In yet another embodiment, the first triggering manipulation includes applying a first triggering force, and the second triggering manipulation includes applying a second triggering force that is significantly different from or greater than the first triggering force. In some such embodiments, the triggering force required to actuate the trigger may be configurable to suit a user's needs. And in one embodiment, an adjustable trigger stop is included for configuring or customizing a throw distance of the trigger.

Thus, some embodiments involve a triggering method that enables activation of different functions of a data reader via a single triggering mechanism. One possible function that may be activated is a mode changing function, which changes the operational mode of the data reader. A further aspect of certain embodiments is to provide a user with the ability to chose in real time which function they want the data reader to perform and to activate that function or to switch operational modes to enable that function with a single hand and single event.

These and other aspects will become apparent from the following description, the description being used to illustrate the preferred embodiments when read in conjunction with the accompanying drawings.

### BRIEF DESCRIPTION OF THE DRAWINGS

FIG. 1 illustrates a functional block diagram of one embodiment of a bar code and radio tag reader.

FIG. 2 is a block diagram of one embodiment using a multiple technology data reader.

FIG. 3 illustrates a block diagram of one embodiment of linear imaging of a bar code label.

FIG. 4 illustrates a block diagram of a hand-held optical reader in one embodiment.

FIG. 5A illustrates a first trigger arrangement in a hand-held reader in a first embodiment.

FIG. 5B illustrates a second trigger arrangement in a hand-held reader in a second embodiment.

FIG. 6A is a block diagram illustrates a method of “double-click” manipulation of a trigger in accordance with one embodiment, for initiating an image capture or transmission event.

FIG. 6B is a block diagram illustrates a method of “double-click” manipulation of a trigger in accordance with another embodiment, for switching the scanner into an image capture mode so that subsequent single-click manipulation initiates an image capture or transmission event.

FIG. 7 illustrates a block diagram of a hand-held RFID reader in one embodiment.

### DETAILED DESCRIPTION OF PREFERRED EMBODIMENTS

While embodiments are described below with reference to optical code readers and RFID readers, skilled persons will appreciate that the principles described herein are viable to a variety of multi-function and multi-mode reader devices. Some embodiments of the triggering methods and devices are directed to multiple technology data readers including an optical data reader and a second function, such as an RFID interrogator for detecting RFID tags and the data they carry. An optical reader of certain embodiments may read optical codes via imaging, laser scanning, or otherwise. While certain embodiments are described herein with reference to bar codes, the embodiments may be useful for other optical codes and symbols, and nothing herein should be construed as limiting the embodiments to bar codes.

The data reader preferably includes a control unit such as a microprocessor in communication with the optical reader or other reader (such as an RFID reader), or both. A computer may be connected to the data reader via a communications unit, and triggering methods according to some embodiments may be used to control the transmission of data between the data reader and the computer, as further described herein.

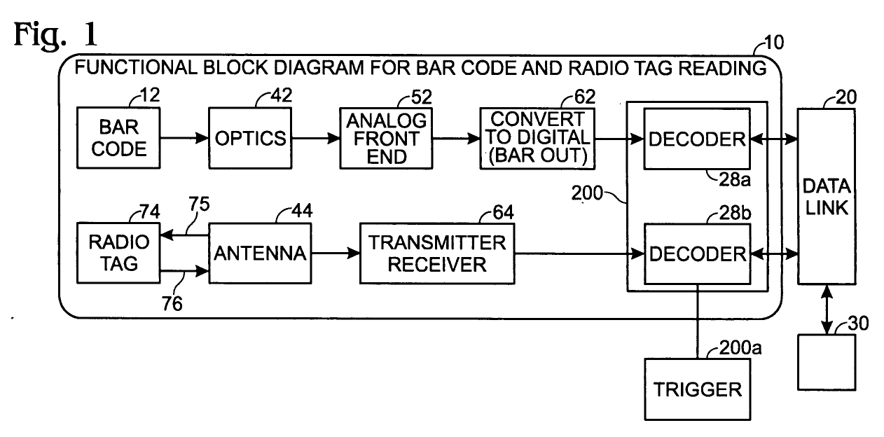

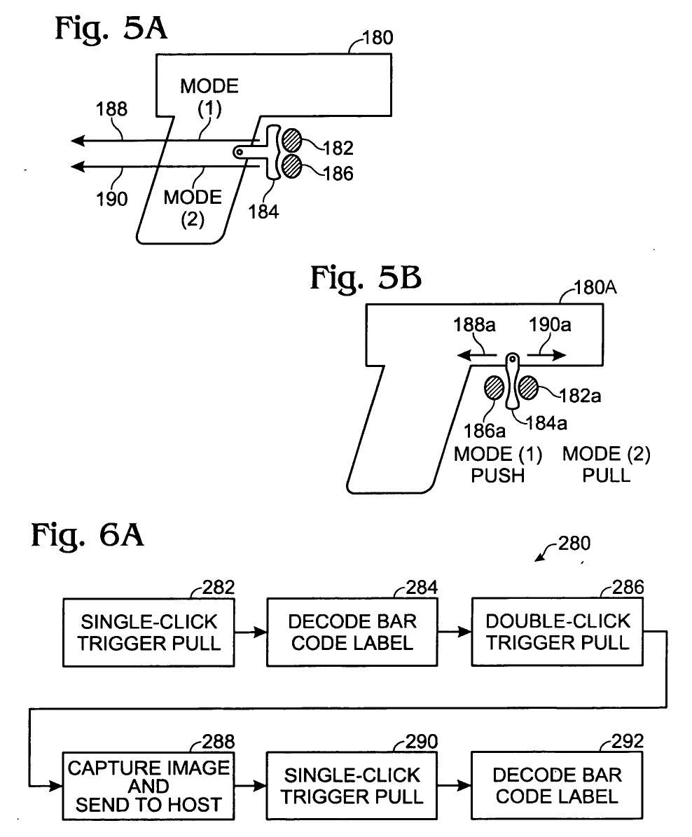

FIG. 1 is a functional block diagram for bar code and radio tag reading system 10, within a multiple technology reader 200, which can read an optical code such as bar code 12 and an RFID transponder 74 or tag. Bar code 12 is read and detected by an optical means 42, which sends a detected signal representative of bar code 12 to an analog front end means 52. The detected signal is then converted to a digital data signal by a converter 62, which may include an A/D converter or another device. The converted signal is decoded by an optical code decoder 28a and then sent to a host computer 30 via a data link 20. The RFID transponder 74 is preferably detected by an antenna 44 that radiates an electromagnetic signal 75 and detects a response signal 76 from the RFID transponder 74. The response signal 76 is received by an RFID transmitter/receiver 64. The response signal 76 is then decoded by an RFID decoder 28b and the decoded data signal is sent to a host computer 30 via the link 20. A trigger switch 200a activates or deactivates the multiple technology reader 200 and may cause reader 200 to switch between modes of operation as further described below. In one embodiment, the trigger switch 200a is operable to switch between a first operational mode for reading optical codes 12 and a second operational mode for reading RFID transponders 74. In some embodiments, the trigger switch 200a may comprise the trigger mechanism 184 of FIG. 5A or the trigger mechanism 184a of FIG. 5B.

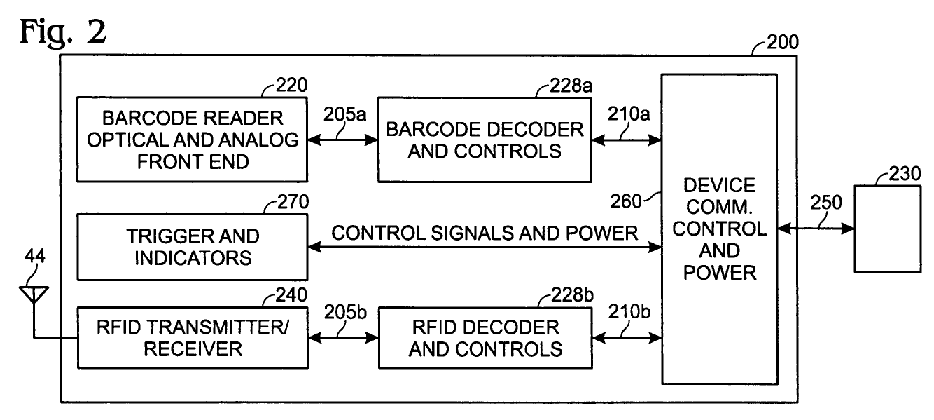

FIG. 2 illustrates the multiple-technology data reader 200 having the optical and analog front end components of an optical code reader subsystem 220. This data reader 200 further includes an antenna 44 and transmitter/receiver components of an RFID interrogator 240. The interrogator 240 and optical code reader subsystem 220 are connected to a device microcontroller including an optical code decoder and control interface 228a and an RFID decoder and control interface 228b. The decoder and control interfaces 228a and 228b are connected to a device communications control and power unit 260. The multiple technology data reader 200 also includes a trigger 270 with feedback indicators. The trigger 270 sends and receives control signals and power, both to and from the device communications control and power unit 260. The device communication control and power unit 260 of data reader 200 is connected to a host computer 230, preferably via a USB link 250, or any other suitable wired or wireless interface. Further details of a multiple-technology reader are described in U.S. Pat. No. 6,415,978 of McAllister, titled “Multiple Technology Data Reader For Bar Code Labels and RFID Tags,” which is incorporated herein by reference.

The optical code decoder and control interface 228a has an input/output endpoint 210a, which enables the host computer 230 to use a default control method to initialize and configure the optical code reader components of data reader 200. Data can be sent in either direction between the optical code decoder and control interface 228a and the optical code reader subsystem 220 via a serial communications line 205a.

Likewise, RFID decoder and control interface 228b has an input/output endpoint 210b, which enables the host computer 230 to use a default control method to initialize and configure the RFID reader components of data reader 200. Data can be sent in either direction between the RFID decoder and control interface 228b and the optical code reader subsystem 240 via a serial communications line 205b.

FIG. 5A illustrates a side elevation hand-held reader 180 with a grip and a trigger mechanism 184 adjacent the grip that allows a user to operate with one hand in either a first mode or a second mode, or to selectively activate multiple functions with one hand, thereby providing to a user preference and function selection in real time. This trigger arrangement may be employed for the trigger 270 of FIG. 2. The trigger mechanism 184 may include a multi-position rocker switch having a rocker arm supporting a pair of control pads for rocking the control arm in opposing first and second rotary directions about a pivot axis of the trigger mechanism. To activate the first mode or function of the data reader 180, the trigger mechanism 184 may be pressed with a first manipulation 188 in which an upper control pad of the trigger mechanism 184 is pulled in the direction of the arrow 188 by using a first finger 182. In addition, the trigger mechanism 184 can be used to activate the second mode or function by applying a second manipulation 190, in which a lower control pad of the trigger arm is pulled in the direction of the arrow 190 by using a second finger 186. For example, the first manipulation 188 may be used to read an RFID tag via an RFID interrogator of the reader 180. When the second manipulation is applied to the trigger mechanism 184, the RFID reading is stopped and a second mode or function of the reader 180 may be activated.

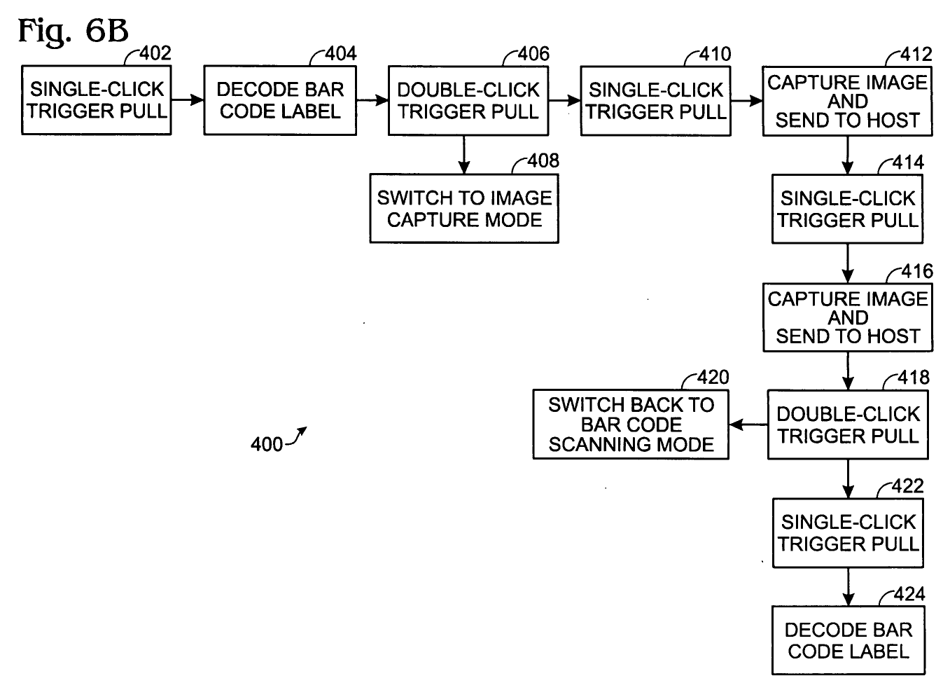

First and second manipulations 188, 190 may be applied to the trigger mechanism 184 to activate corresponding different first and second functions of the reader 180. If the reader 180 is a multiple technology data reader as shown in FIG. 1, the reader 180 may be configured to activate the RFID interrogator 64 (transmitter/receiver) and antenna 44 when the trigger mechanism 184 is pulled in the first manipulation 188. When the second manipulation 190 is applied to the trigger mechanism 184, the data reader may activate the optical means 42. Furthermore, the trigger mechanism 184, which is designed for a first manipulation 188 and second manipulation 190, may be configured to activate various functions including, but not limited to, image capture, bar code decode, cold reset, warm reset, scan, suspend, power and the like. In addition, the trigger mechanism 184 or a control unit of the reader 180 may be configured to recognize multiple different trigger manipulations, including a first manipulation 188, a second manipulation 190, a third manipulation (not shown) and a fourth manipulation (not shown), in which the third and fourth manipulations are in sideways directions relative to the first and second manipulations. A 4-way trigger or 4-way rocker switch of this kind may provide movement of a cursor, for example, in a display screen (not shown) of the reader 180. In some embodiments, the trigger mechanism 184 or the control unit of the reader 180 may be configured to accept or recognize various other manipulations different from the first and second manipulations 188 and 190. Examples of other possible manipulations are described with reference to FIGS. 6A and 6B, below, and elsewhere herein.

The trigger mechanism 184 may be a variable force trigger wherein the user has the ability to adjust the reader 180 for desired preferences and/or functionality. The movement of the trigger mechanism 184 may be force-adjustable. That is to say that the force required to actuate the trigger mechanism 184 in either the first manipulation direction 188 or the second manipulation direction 180, or both, may be selectively set. Varying force resistance or biasing force on the trigger mechanism 184 may allow the user to switch to different preference settings. A configurable selectable trigger mechanism 184 would preset the trigger force for a specific end user. In one embodiment, an externally adjustable switch may be employed to adjust the resistance force on trigger mechanism 184 through a predetermined range. In one embodiment, an adjustable spring is mounted so as to allow a physical external adjustment by the user of the trigger mechanism 184. Alternately, the adjustable resistance force on the trigger mechanism 184 can be achieved through the use of electrical circuits and the like. In another embodiment, there may be the addition of a preset number of selectable trigger mechanism orientations that would result in a preset number of different force requirements on the trigger mechanism 184.

In still another embodiment, the trigger mechanism 184 may include an adjustable stop for selectively adjusting or limiting a travel distance or throw of the trigger from its resting position to a fully depressed position.

One trigger mechanism for selectively activating multiple functions in a data reader employs a force sensitive device in the trigger mechanism 184, such as a force sensitive resistor (FSR) that is operably interposed in the triggering circuit to produce different trigger output signals when different amounts of force are applied to the trigger mechanism. For example, a force sensitive trigger may output a first signal in response to a first triggering manipulation of light force for selectively activating a first function of the data reader, and may further output a second signal in response to a second triggering manipulation of heavier force for selectively activating a second function of the data reader. A control unit (such as the control unit 260 of FIG. 2) is in communication with the trigger mechanism 184 and is operable in response to receipt of the first signal to activate a first function of the data reader and further operable in response to receipt of the second signal to activate a second function of the data reader. For example, the receipt of the first signal may cause the control unit to activate an aiming light source of the data reader (not shown) for projecting an aiming beam that can be directed at a target surface to facilitate aiming of the data reader. Furthermore, the control unit may cause the data reader to read an optical code in response to receipt of the second signal representing the second triggering manipulation. In an alternative implementation, the control unit may respond to receipt of the second signal by capturing an image and storing image data representative of the image. The captured image data may immediately transmitted to a host computer 230, or may be stored for later transmission. In one embodiment, the stored image data is transmitted to the host computer 230 after a third triggering manipulation in which the triggering force is substantially greater than or different from the forces of the first and second triggering manipulations.

Different triggering manipulation forces may also be used to activate other functions and modes in multi-function and multi-mode data readers. Non-limiting examples of other functions and modes are described herein with reference to other figures and embodiments, and include such features as RFID, optical code scanning, data transmission, bar code decode, cold reset, warm reset, scan, suspend, and power on/off, for example. A force sensitive triggering device may also be used in combination with other triggering manipulation methods described herein, such as the double-click triggering method described below with reference to FIGS. 6A and 6B.

FIG. 5B illustrates a hand-held reader 180A with a trigger mechanism 184a that allows a user to employ a first trigger manipulation 188a and a second trigger manipulation 190a, providing to a user preference and function selection in real time. This trigger arrangement is substitutable for the trigger 270 as shown in FIG. 2. The first trigger manipulation 188a involves pulling the control arm of the trigger mechanism in the direction of the arrow 188a by using a first finger 182a. In addition, the second trigger manipulation 190a involves pushing the control arm of the trigger mechanism 184a in the direction of the arrow 190a by using a second finger 186a. For example, the first trigger manipulation 188a may be used to adjust the RF power transmitted by the RFID reader relative to an RFID tag of interest. That tag may be singulated with its individual identity read, even though more tags may be present within the normal read volume of the RFID reader. The second trigger manipulation 190a may cause the RFID reader to stop reading or to decrease the RF power.

Another example of using the trigger mechanism 184a and the first and second trigger manipulations 188a, 190a includes activating corresponding different functions of the reader 180A. If the reader 180A is a multiple technology data reader as shown in FIG. 1, it may be configured to activate the RFID interrogator 64 (transmitter/receiver) and antenna 44 when the trigger mechanism 184a is pulled in the first triggering manipulation 188a. The reader may further be configured to activate the optical reader or imager 42, when the trigger mechanism 184a is pushed in the second triggering manipulation 190a. Furthermore, the trigger mechanism 184a with a first trigger manipulation 188a (pull) and second trigger manipulation 190a (push) may be configured to activate various functions including, but not limited to, image capture, bar code decode, cold reset, warm reset, scan, suspend, power on/off and the like. In addition, the trigger mechanism 184a may further comprise a device for receiving first triggering manipulation 188a, second triggering manipulation 190a, a third triggering manipulation (not shown) and a fourth triggering manipulation (not shown), wherein the third and fourth triggering manipulations are transverse relative to the first and second triggering manipulations, allowing the user a 4-way trigger or rocker. One possible use of a 4-way trigger would be moving a cursor around a display screen of the reader 180a (not shown).

The trigger mechanism 184a may include a variable trigger wherein the user has the ability to adjust the reader 180A for desired preferences and/or functionality. The first trigger manipulation 188a (pull) or the second trigger manipulation 190a (push) may be force adjustable, that is, a user may vary the required force for either the first or second manipulations 188a, 190a of the trigger mechanism 184a. Varying the required force on the trigger mechanism 184a, when the user is either pushing or pulling the trigger, would allow the user to switch to different functions or preferences. A configurable selectable trigger mechanism 184a would preset the trigger force for a specific end use or for tactile feedback. A force sensitive trigger mechanism 184a would perform different functions (including a mode switching function) in response to different amounts of force applied to trigger mechanism 184a. In one embodiment, there might be the addition of an externally adjustable switch that would be able to adjust the trigger mechanism 184a force through a predetermined range. In another embodiment, an adjustable spring may be mounted so as to allow a physical external adjustment by the user of the trigger mechanism 184a. Alternately, the adjustable force on the trigger mechanism 184a could be achieved through the use of electrical circuits and the like. In another embodiment, a preset selectable trigger mechanism 184 may have different orientations that can be selected to result in a number of different force requirements for the trigger mechanism 184a.

The force-sensitive trigger mechanism and adjustable trigger travel or throw distance described above with reference to FIG. 5A may also be employed in a similar manner with the trigger mechanism 184a of FIG. 5B.

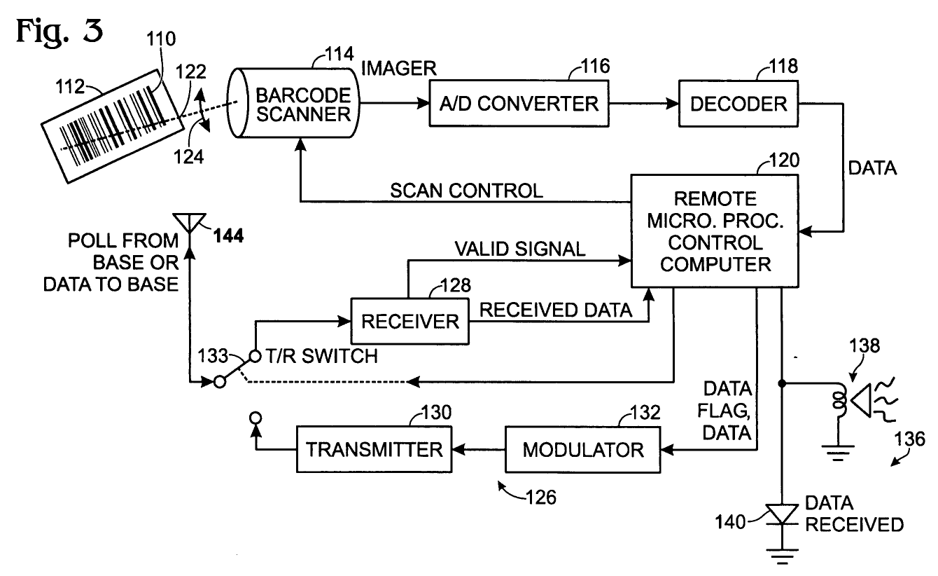

FIG. 3 illustrates a remote optical code reader for reading an optical code 110 on a label 112, which may be attached to an item and identifies that item. The data representing the item is obtained by a mobile data terminal such as an optical code scanner 114. The scanner 114 provides bar code image signals which are digitized as by an analog to digital converter 116. Also, optical code scanner 114 may provide bar code image signals by the digitizer circuit as described in U.S. Pat. No. 5,864,129 of Boyd, titled “Bar Code Digitizer Including Voltage Comparator,” which is incorporated herein by reference. The digitized signal is transmitted to the decoder 118 to provide serial binary data representing the bar code. This data is inputted into a microprocessor controller 120 in the remote unit. The controller 120 exercises several functions initiated by a trigger mechanism 133. These functions include, but are not limited to, a scan control signal generation for enabling the bar code imager to scan across the code 110 in the direction of the arrow 124, when the label 112 comes into proximity of the scanner.

Wireless data communications features are provided by a radio-frequency transceiver 126 including a receiver 128, a transmitter 130 and modulator 132. The transmitter and modulator provide transmission where a carrier is moved between states, according to different binary bits of a message. For example, the output frequency in an embodiment of the invention may be in the ultra-high frequency (UHF) band, in the very high frequency (VHF) band or other bands at a relatively low power. In typical applications such as in warehouses and factories, low power transmitters are sufficient to cover a large enough area for remote collection of data from bar code scanners.

The receiver 128 operates at the same frequency as the transmitter 130. The receiver 128 and the transmitter 130 are connected to an antenna 144 using a trigger mechanism 133 (such as a transmit-receive (T/R) switch), which is controlled by a signal from the controller 120. This wireless collection of data is described in U.S. Pat. No. 5,581,707 of Kuecken, titled “System For Wireless Collection Of Data From A Plurality Of Remote Data Collection Units Such As Portable Bar Code Readers,” which is incorporated herein by reference. This reader may use the principles of the triggering methods and devices described elsewhere in this disclosure to control the transmission and flow of data and messages between the mobile data terminal and a host or base station.

The control unit 120 may operate an annunciator 136, which may include an audible signal generator and speaker 138 and a data received indicator LED (light emitting diode) 140. In this embodiment, the trigger mechanism 133 may include the trigger mechanism 184 of FIG. 5A or the trigger mechanism 184a of FIG. 5B.

FIG. 6A illustrates a first triggering method 280 for use with an imaging reader to switch between a first function of capturing an image for decoding an optical code present therein and a second function of capturing an image for transmission to the host computer. The first triggering method 280 may be implemented with a rocker switch, for example, or with other triggering mechanisms, such as one of the trigger mechanisms 184, 184a of FIGS. 5A and 5B, and in readers as shown in FIGS. 2 and 3. In the first triggering method 280, when the trigger mechanism 184 (or 184a) is twice moved in the first direction 188 (or 188a) in quick succession (i.e., pulled twice for a “double click”), the trigger mechanism 184/184a initiates a single image capture event and sends the captured image data to the host computer. If the trigger mechanism 184/184a is only once moved in the first direction 188/188a—i.e., pulled once in a single click—the reader 180/180A then attempts to decode an optical code in the image at step 284. Next, the user at step 286 applies a double click pull on the trigger mechanism 184/184a in the first direction 188/188a. This double click pull activates step 288 wherein the image is captured and sent to a host computer. At step 290, the user provides a second single click pull on the trigger mechanism 184/184a in the first direction 188/188a. This activates step 292 wherein the second optical code label is decoded. The methods illustrated in FIG. 6A may also be utilized with other kinds of trigger switches, including a simple push-button single-pole single-throw trigger switch, for example.

FIG. 6B illustrates a second triggering method 400 for use with an imaging reader to switch between a first operating mode for capturing an image and decoding a bar code contained therein and a second operating mode for capturing an image for transmission to the host computer. The second triggering method 400 may be used with the embodiments as shown in FIGS. 5A and 5B and in readers as shown in FIGS. 2 and 3. In the second triggering method 400 when the trigger mechanism 184/184a is twice moved in a first direction 188/188a in quick succession (i.e., pulled twice for a “double click”), the trigger mechanism 184/184a switches the data reader 180/180A into an image capture mode so that a subsequent single click of the trigger mechanism 184/184a causes the imaging reader to capture images and send them to the host computer. Another double click of the trigger mechanism 184/184a, returns the data reader 180/180A to a normal optical code reading mode. If the user attempts to read a bar code while the data reader 180/180A is in image capture mode, an alert, such as a flashing LED or distinctive audible sound may be produced to indicate that an optical code was present in the image but not decoded. If, after an audible or visual alert, a user double-clicks the trigger mechanism 184/184a within a preset response time, the data reader 180/180A will preferably proceed to decode any labels in the stored image. The data reader 180/180A configuration would then preferably indicate whether the scanner stayed in the image capture mode or returned to the bar code scanning mode after decoding the stored image. Alternately, the trigger mechanism 184/184a is substitutable for use with software that will allow bar code or optical labels that are in a captured image to be automatically decoded.

In a manual mode, the user at step 402 of the second triggering method 400 applies a first single click on the trigger mechanism 184/184a. This first single click activates step 404 wherein there a first optical code label is decoded. Next, at step 408, the user applies a first double click on the trigger mechanism 184/184a. This first double click activates step 408 which switches the data reader 180/180A to an image capture mode. At step 410, the user applies a second single click on the trigger mechanism 184/184a. This second single click activates step 412 wherein a first image is captured and sent to a host computer. At step 414 the user applies a third single click on the trigger mechanism 184/184a. This third single click activates step 416 wherein a second image is captured and sent to the host computer. Next, at step 418, the user applies a second double click on the trigger mechanism 184/184a. This second double click activates step 420 which switches back to the bar code scanning mode. Finally, at step 422, the user applies a fourth single click on the trigger mechanism 184/184a. This fourth single click activates the step 424 of decoding the second optical code label.

The double click methods 280 and 400 of FIGS. 6A and 6B may be employed to capture images and store them in association with barcode data read during the same reading session. For example, the data decoded at step 284 of method 280 may be stored in a memory of the reader or transmitted to a host. Upon the next step of the double-click trigger 284 the reader will capture an image and store image data it in association with the decoded bar code data or transmit the image data to the host for storage or image display in association with the decoded bar code data of step 284. One situation in which association of image data with bar code data may be useful is in connection with package delivery. For example, package delivery personnel may carry an imaging reader according to one of the embodiments described herein for scanning bar codes on packages at the time of delivery, followed by imaging of a receiving person for positive identification or for recordkeeping purposes for proof of delivery. Other possible uses include check cashing identification and proof of identification, including using the imaging reader in a first mode for scanning an optical code present on the check presenter's driver's license, followed by using the imaging reader in a second mode to take a picture of the presenter. The triggering methods described herein may simplify and streamline the steps of acquiring data from optical codes and acquiring images.

In an alternative embodiment, the triggering methods of FIGS. 6A and 6B may be used with a multi-function reader including both optical reader capabilities and RFID capabilities, or with a multi-function reader laser scanning capabilities and imaging capabilities, for example.

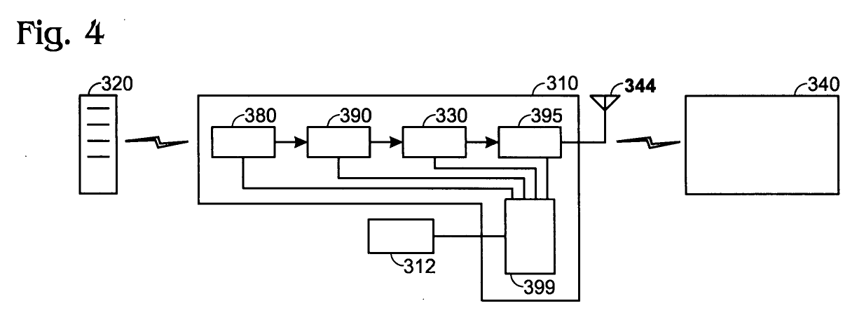

FIG. 4 shows an optical reader with a trigger mechanism 312 that may use trigger mechanism 184/184a of FIGS. 5A and 5B and the first triggering method 280 of FIG. 6A or the second triggering method 400 of FIG. 6B. In the system, a bar code scanner 310 is used to scan a bar code 320. Once the bar code scanner 310 has successfully scanned the bar code 320, the raw bar code data is digitized and stored in a memory 330 internal to the optical code scanner 310. The return data, which corresponds to light reflected off of the bar code symbol, is received by a photodiode detector 380 and then the raw data is sent to a digitizer 390. The digitized data is then stored in a memory 330. The trigger mechanism 312 is used to activate the first triggering method 280 or the second triggering method 400 and to thereby send modulated data to a computer 340. Other embodiments are described in U.S. Pat. No. 6,024,284 of Schmid et al., titled “Wireless Bar Code Scanning System,” which is incorporated herein by reference. The scanner of Schmidt et al. may also be modified to utilize the principles of other triggering methods and devices described in this disclosure.

When desired, the data is retrieved from the memory 330 modulated by modulator 395. The data is sent via an antenna 344 to a computer 340 which is located separate from the bar code scanner 310. The “when desired” may correspond to a particular time frame which the computer 340 is in a receiving mode, such as a particular time division multiple access (TDMA) time slot. Alternately, the digitized data may be immediately sent out to the computer 340 as soon as it is digitized by the digitizer 380, wherein memory 330 is not needed. A control unit 399 at the bar code scanner 310 provides control of the wireless transmission or reception of data to the computer 340. Control unit 399 may be responsive to a first manipulation of the trigger mechanism 312 to read optical data codes and responsive to a second manipulation of the trigger mechanism 312 to wirelessly transmit data to the computer 340.

The means of wireless transmission may be by radio frequency signals, infrared signals or ultrasonic transmission. The data may be sent via data packets or continuous streams of data, depending upon the amount of transmission signal processing which is done at the bar code scanner 310. In addition, the data may be subject to forward error correction (FEC), via an FEC encoder (not shown) resident in the bar code scanner 310. One such bar code scanner that can be utilized with the present invention is described in U.S. Pat. No. 5,665,956 of La et al., titled “Bar Code Reading And Data Collection Unit With Ultrasonic Wireless Data Transmission,” which is incorporated herein by reference. This reader may use the principles of the embodiments as described in this disclosure in connection with the devices of La et al.

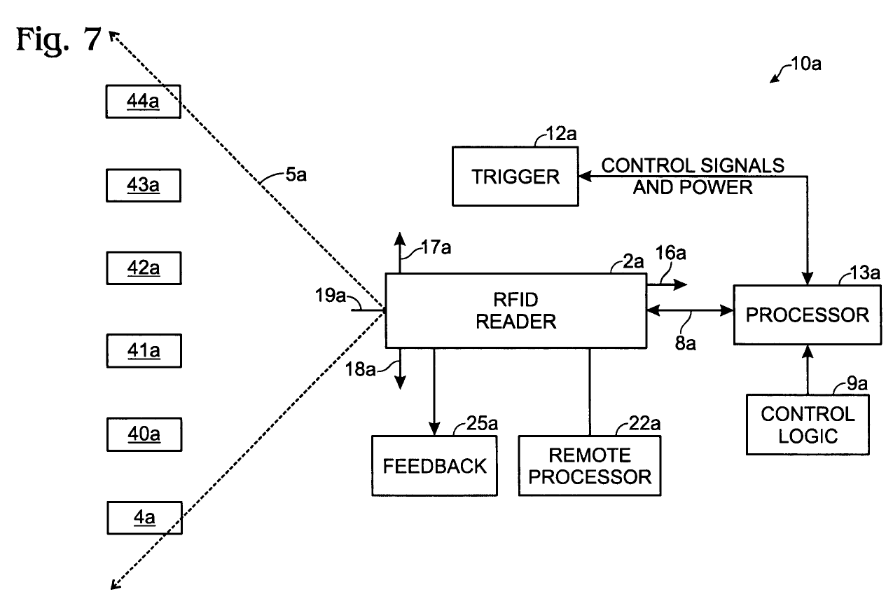

FIG. 7 illustrates a block diagram of an RFID interrogator 10a. The RFID interrogator 10a uses a RFID reader 2a to scan for a particular RFID tag(s) in a plurality of RFID tags, including but not limited to, 4a, 40a, 41a, 42a, 43a and 44a. The RFID interrogator 10a is preferably a handheld RFID reader 2a, wherein the RFID reader 2a passes over the RFID tags 4a, 40a, 41a, 42a, 43a and 44a. Alternately, the RFID reader 2a is substitutable for a fixed reader, wherein RFID tags 4a, 40a, 41a, 42a, 43a and 44a are passed in front of the reader. The RFID reader 2a may be connected via a USB link 8a or other interfaces to processor 13a. The interface link can be hardwired to an infrared modem connection, an RF modem connection, a combination of connections or any other suitable connections. RFID reader 2a may also include a self-contained micro-processor and be capable of storing data, and may or may not interface with a remote processor 22a. Processor 13a receives control input from logic control 9a for communication with RFID reader 2a. Logic control 9a may be programmable and part of processor 13a or may be separate. An activation switch, such as trigger mechanism 12a, provides control signals and power to processor 13a . Consequently, a first manipulation of the trigger mechanism 12a may activate a singulation scheme, such as the one described in U.S. patent application Ser. No. 11/055,960 entitled “RFID Power Ramping For Tag Singulation,” which is incorporated herein by reference. This singulation scheme may locate a particular RFID tag, for example, tag 41a from amongst RFID tags 4a, 40a, 41a, 42a, 43a and 44a. The amount of power increase depends on the power level step provided by the module design. The first manipulation 188/188a may be used to adjust the RF power transmitted by the RFID reader relative to a single RFID tag of interest. That tag may be singulated with its individual identity read, even though more tags may be present within the normal read volume of the RFID reader. If the initial manipulation of the trigger mechanism 184/184a is a pull in a first direction 188/188a, the system transmits 6-10 db below the maximum allowed power, then as the trigger mechanism 184 and 184a remains activated the system increments the power level in 1-2 db increments. When a second manipulation of the trigger mechanism 184/184a involves movement of the trigger arm in a second direction different from the first direction, the RFID tag reader is stopped or the power is decreased in an amount based on the power level step provided by the module design. If the maximum power level is reached before the trigger is released then the reading of an RFID tag is stopped automatically.

Trigger mechanisms 184, 184a of FIGS. 5A and 5B may be used for trigger mechanism 12a. The power-density-time (PDT) control that provides a ramped power control may be accomplished by use of multi-function trigger mechanism 184/184a. The singulation scheme would begin when the trigger mechanism 184/184a is pulled and held in a first trigger manipulation 188/188a. The read would continue for as long as the trigger is held, up to the point of maximum power. Depending on what RFID tag is to be identified from the tags 4a, 40a, 41a, 42a, 43a and 44a, the trigger mechanism 184/184a would be moved in a second triggering direction 190/190a to generate a transmitter power, wherein a particular tag is identified from among the tags, 4a, 40a, 41a, 42a, 43a and 44a. In addition to trigger mechanism 184/184a, the apparatus 10a may optionally include a feedback mechanism 25a. One such mechanism may comprise a progress bar on a LCD increasing as the transmitting power increases. This feedback allows the user to judge whether or not the read effort is successful because a singulation read may take longer than a normal read.

Alternately, the feedback mechanism 25a may comprise an auditory feedback that generates an audible signal when a RFID tag is read or when maximum power is achieved. This auditory feedback may include, but is not limited to, increasing a pitch sequence of tone-beeps working with the transmitter power.

It will be obvious to those having skill in the art that many changes may be made to the details of the above-described embodiments without departing from the underlying principles of the invention. The scope of the present invention should, therefore, be determined only by the following claims.

1. A method of operating a handheld data reader including a manual trigger, comprising:
activating a first function of the data reader to read data by a first single click of the trigger;
activating a second function of the data reader by a double click of the trigger; and
after activating the second function, activating the data reader again by a second single click of the trigger.

2. The method of claim 1, wherein the step of activating the second function includes switching an operational mode of the data reader, from a data reading mode to an image capture mode.

3. The method of claim 2, wherein the trigger has a full travel distance, and further comprising:
activating an aiming illumination beam of the data reader by moving the trigger a fraction of the full travel distance.

4. The method of claim 1, wherein the step of activating the second function includes capturing a set of image data representing an image and transmitting the set of image data to a host computer.

5. The method of claim 1, wherein the step of activating the data reader by the second single click includes reading an optical code.

6. The method of claim 1, wherein the step of activating the data reader by the second single click includes capturing a set of image data representing an image.

7. The method of claim 6, further comprising activating the data reader a third time to capture a second set of image data representing a second image by a third single click of the trigger.

8. The method of claim 6, further comprising:
analyzing the image for the presence of an optical code; and
presenting an alert in response to the detection of an optical code in the image.

9. The method of claim 1, further comprising, after the step of activating the data reader by the second single click, switching the operational mode of the data reader by a second double click of the trigger.

10. The method of claim 9, further comprising, after the step of switching the operational mode of the data reader by the second double click, activating the data reader to read data by another single click of the trigger.

11. The method of claim 1, further comprising decoding an optical code.

12. A data reader system, comprising
a manual trigger means for activating a first function of the data reader to read data in response to a first single click of the manual trigger means;
the manual trigger means operable to activate a second function of the data reader in response to a double click of the manual trigger means; and
the manual trigger means operable to activate the data reader again in response to a second single click of the manual trigger means after activating the second function.

13. A data reader system, comprising:
a manual trigger operable to:
activate a first function of the data reader to read data in response to a first single click of the trigger;
activate a second function of the data reader in response to a double click of the trigger; and
after activating the second function, to activate the data reader again in response to a second single click of the trigger.

14. A handheld data reader, comprising:
a reader control unit;
a manual trigger in communication with the control unit, the trigger including a force sensor that emits a first output signal in response to a first force applied to the trigger and emits a second output signal in response to a second force applied to the trigger, wherein the second force is significantly different from the first force,
the control unit being operable in response to receipt of the first output signal to activate a first function of the data reader, and
the control unit being operable in response to receipt of the second output signal to activate a second function of the data reader different from the first function.

15. The handheld data reader of claim 14:
wherein the second force is greater than the first force;
wherein the data reader includes an aiming beam source in communication with the control unit to emit an aiming beam in response to the first signal; and
wherein the data reader includes an optical reader in communication with the control unit for reading an optical code in response to the second signal.

16. The handheld data reader of claim 14, further comprising an imaging reader in communication with the control unit:
wherein the second force is greater than the first force;
wherein the control unit is operable to activate the imaging reader for reading an optical code in response to the first signal; and
wherein the control unit is operable to activate the imaging reader for capturing an image in response to the second signal.

17. The handheld data reader of claim 16, wherein the control unit is further operable to transmit the image to a host computer in response to the second signal.

18. the handheld data reader of claim 14, wherein the force sensor comprises a force sensitive resistor.

19. A method of operating a handheld data reader including a manual trigger in communication with a control unit, comprising:
pressing the trigger with a first triggering manipulation to generate a first signal;
activating a first function of the data reader in response to receipt at a control unit of the data reader of the first signal;
pressing the trigger with a second triggering manipulation different from the first triggering manipulation to generate a second signal distinguishable from the first signal; and
activating a second function of the data reader in response to receipt at the control unit of the second signal.

20. The method of claim 19, wherein the first triggering manipulation includes pulling the trigger in a first direction and the second triggering manipulation includes pushing the trigger in a second direction opposite the first direction.

21. The method of claim 19, wherein:
the trigger includes a rocker switch having a control arm;
the first triggering manipulation includes rocking the control arm of the rocker switch in a first rotational direction; and
the second triggering manipulation includes rocking the control arm of the rocker switch in a second rotational direction opposite the first rotational direction.

22. The method of claim 19, wherein:
the first triggering manipulation is a single click; and
the second triggering manipulation is a double click.

23. The method of claim 19, wherein:
the first triggering manipulation includes applying a first triggering force; and
the second triggering manipulation includes applying a second triggering force that is significantly greater than the first triggering force.

24. The method of claim 19, wherein:
the step of activating the second function of the data reader includes switching an operational mode of the data reader.
